(19) United States
(12) Patent Application Publication
(10) Pub. No.: US 2024/0219525 A1
(43) Pub. Date: Jul. 4, 2024

(54) TELESCOPE RANGEFINDER

(71) Applicant: GUOFEI XIANG, Jiaxing (CN)

(72) Inventor: GUOFEI XIANG, Jiaxing (CN)

(21) Appl. No.: 18/221,532

(22) Filed: Jul. 13, 2023

(30) Foreign Application Priority Data
Dec. 29, 2022 (CN) 202223609708.6

(51) Int. Cl. G01S 7/481

(52) U.S. Cl. CPC G01S 7/4812

(57) ABSTRACT

The present application discloses a telescope rangefinder, which is related to the technical field of rangefinder. The key points of the proposed technical scheme are: the telescope rangefinder comprises an objective group, a laser receiver, a laser emission module, a spectroscope group, a display element, and an eyepiece group. The spectroscope group comprises a first prism, a second prism, and a third prism. The first prism comprises a first light input surface, a first reflector, and a second reflector. The second prism is located below the first prism. The second prism comprises a second optical input surface, a third reflector, and a laser output surface, which are parallel to the second reflector. The third prism comprises a third optical input surface, a fourth reflector, and a fifth reflector, which are parallel to the first reflector. The present application aims to provide a telescope rangefinder.

### CROSS-REFERENCE TO RELATED APPLICATIONS

This application claims the benefit and priority of Chinese patent application No. 202223609708. 6, filed on Dec. 29, 2022, disclosure of which is hereby incorporated by reference in its entirety.

### TECHNICAL FIELD

The present application relates to the technical field of rangefinder devices, in particular to a telescope rangefinder device.

### BACKGROUND

The rangefinder is an instrument designed for measuring length and distance by using the reflection and interference of light, sound, and electromagnetic wave. In addition to length measurement, the new rangefinder can use the length measurement results to calculate the area, circumference, volume, mass, and other parameters of the measured target scientifically. It has a wide range of applications in engineering, GIS survey, military and other fields.

Telescope rangefinder, is a branch of laser rangefinder, or called long-range laser rangefinder. Telescope rangefinder generally uses the pulse method to measure distance. The process of pulse method is: the laser emitted by the rangefinder is reflected by the measured object and is received by the rangefinder; meanwhile, the rangefinder records the time of the laser round trip. Half the product of the speed of light and the round-trip time is the distance between the rangefinder and the measured object. The accuracy of the pulse method to measure the distance is around +/−1 meter.

Most of the existing telescope rangefinder optical systems are composed of three parts, such as the observation system, transmission system, and receiving system. Most of time, compensation prism with a complex structure is necessary. Moreover, because the objective lens' and the laser receiver's optical paths are not coaxial, the product is large and immobile. Therefore, a new technical solution is urgently needed.

### SUMMARY

Aiming at the shortcomings of the existing technology, the present application aims to provide a telescope rangefinder.

The technical purpose of the present application is achieved through the following schemes: a telescope rangefinder comprises an objective lens group, a laser receiver, a laser emission module, a spectroscope group, and an eyepiece group. The spectroscope group comprises a first prism, a second prism, and a third prism. The first prism comprises a first light input surface, a first reflector, and a second reflector. The second prism is located below the first prism. The second prism comprises a second optical input surface, a third reflector, and a laser output surface, which are parallel to the second reflector. The third prism comprises a third optical input surface, a fourth reflector, and a fifth reflector, which are parallel to the first reflector.

The light path received by the objective lens group enters the first prism through the first optical input surface and enters the third prism through the third optical input surface after the reflection of the first reflector and the second reflector. Then the light path enters the eyepiece group through the reflection of the fourth reflector, the fifth reflector, and the third optical input surface.

The laser light path enters the first prism through the objective group. The light path enters the second prism through the first reflector and the laser receiver through the third reflector.

By utilizing the new technology, the optical paths of the laser receiver and the objective lens group are coaxial through the spectroscope group. Therefore, the product becomes portable.

The present application is further arranged as follows: the laser emission module comprises a laser emitter and a transmitting lens group on the transmitting optical path.

The present application is further arranged that the first prism and the second prism are fixed and connected through the glueing of the second light reflecting surface and the second light input surface. The second light reflecting surface and the second light input surface are plated with a penetrating film layer conducive to laser input and output.

The present application is further arranged that the laser transmitting module is interchangeable with the laser receiver.

The present application has the following benefits: the optical paths of the laser receiver and the objective group are coaxial through the splitter group, reducing the volume of the product and making the product portable.

### BRIEF DESCRIPTION OF DRAWINGS

FIG. 1 is the schematic diagram of the overall structure of this embodiment.

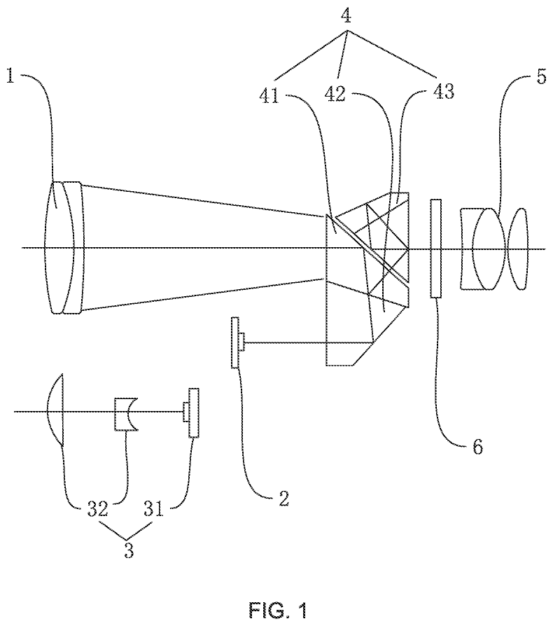

FIG. 2 is the structural diagram of the first prism of this embodiment.

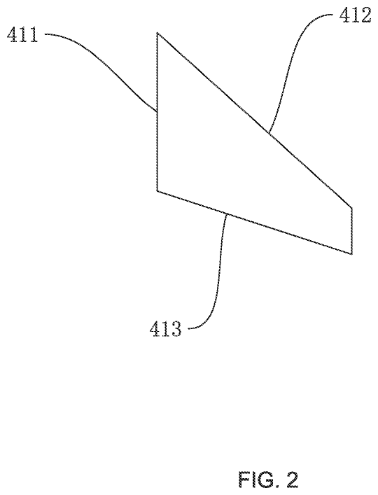

FIG. 3 is the structural diagram of the second prism of this embodiment.

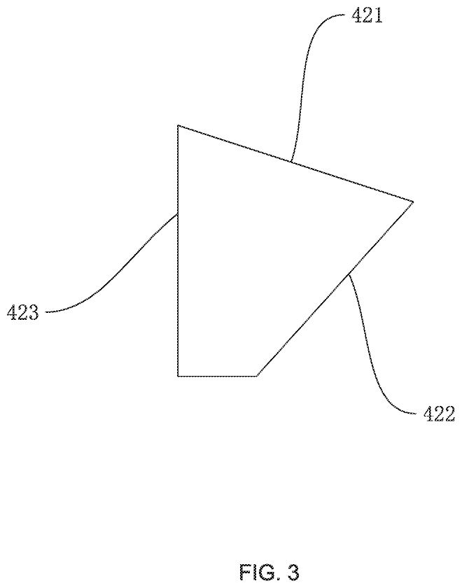

FIG. 4 is the structural diagram of the third prism of this embodiment.

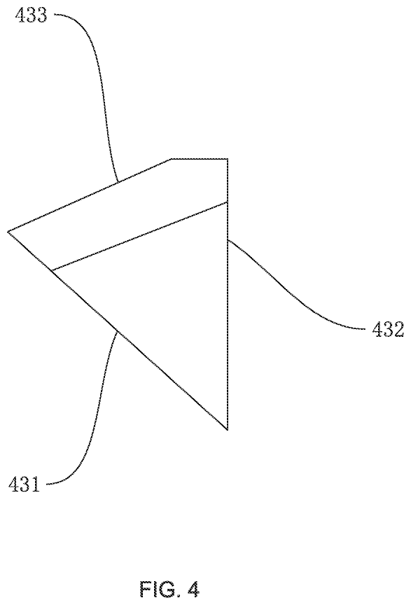

In the drawings: 1. Objective lens group; 2. Laser receiver; 3. Laser emission module; 31. Laser transmitter; 32. Transmitting lens group; 4. Spectroscope group; 41. First prism; 411. First light input surface; 412. First reflector; 413. Second reflector; 42. Second prism; 421. Second light input surface; 422. Third reflector; 423. Laser output surface; 43. Third prism; 431. Third light input surface; 432. Fourth reflector; 433. Fifth reflector; 5. Eyepiece group; 6. Display components.

### DETAILED DESCRIPTION

The present application is further explained in detail in combination with the attached drawings.

The same parts are represented by the same drawings. It should be noted that the words “front”, “back”, “left”, “right”, “up” and “down” used in the following description refer to the directions in the attached drawings. The words “bottom”, “top”, “inside” and “outside” refer to the directions towards or away from the geometric center of a particular part respectively.

As shown in the figure, a telescope rangefinder comprises an objective lens group 1, a laser receiver 2, a laser emission module 3, a spectroscope group 4, an eyepiece group 5, and a display element 6. The spectroscope group 4 comprises a first prism 41, a second prism 42, and a third prism 43. The first prism 41 is specifically a semi-pentaprism, and the second prism 42 is specifically a triangular prism. The third prism 43 is specifically a ridge prism. The first prism 41 comprises the first optical input surface 411, the first reflector surface 412 and the second reflector surface 413. The second prism 42 is located below the first prism 41. The second prism 42 comprises the second optical input surface 421, the third reflector surface 422 and the laser output surface 423, which are parallel to the second reflector surface 413. The third prism 43 comprises the third optical input surface 431, the fourth reflector 432, and the fifth reflector 433, which are parallel to the first reflector 412.

The white light path received by objective group 1 enters the first prism 41 through the first optical input surface 411. Then, the white light path enters the third prism 43 through the third optical input surface 431 after the reflection of the first reflector 412 and the second reflector 413. Then, the white light path enters the eyepiece group 5 through the reflection of the fourth reflector 432, the fifth reflector 433 and the third optical input surface.

The laser light path received by objective group 1 enters the first prism 41 and enters the second prism 42 through the first reflector 412. Then, the laser light path enters the laser receiver 2 through the third reflector 422.

The optical paths of the laser receiver 2 and the objective group 1 are coaxial through the splitter group 4, reducing the product volume and making the product portable.

The laser emission module 3 comprises a laser emitter 31 and a transmitting lens group 32 on its transmitting optical path. The laser emitter 31 emits laser light through the transmitting lens 32. The laser light is reflected into the objective lens group 1 and into the laser receiver 2 through the first prism 41 and the second prism 42.

The first prism 41 and the second prism 42 are bonded to the second light input surface 421 and the second light reflector surface 413. The second light reflector surface 413 and the second light input surface 421 are plated with a penetrating film layer (not shown in the figure) that is conducive to laser input and output. By setting the penetrating film layer, the white light can be reflected through the second reflector surface 413. Then, the white light is transmitted into the third prism 43 and finally into the eyepiece group 5, so that the laser can smoothly enter the second prism 42.

The laser transmitter module 3 is interchangeable with the laser receiver 2 for production according to the model specifications of different products.

The specific embodiment is only the interpretation of the present application and is not a limitation of the present application. The technical personnel in the field may make modifications to the embodiment without creative contribution as needed after reading the manual, as long as it is within the scope of the claims of the present application. This is protected by the patent law.

What is claimed is:

1. A telescope rangefinder comprises an objective lens group, a laser receiver, a laser emission module, a spectroscope group, a display element and an eyepiece group. These are characterized in that: the spectroscope group comprises a first prism, a second prism, and a third prism. The first prism comprises a first light input surface, a first reflector, and a second reflector. The second prism is located below the first prism. The second prism comprises a second light input surface, a third reflector, and a laser output surface, which are parallel to the second reflector. The third prism comprises a third optical input surface, a fourth reflector, and a fifth reflector, which are parallel to the first reflector;
The light path received by the objective lens group enters the first prism through the first optical input surface and enters the third prism through the third optical input surface after the reflection of the first reflector and the second reflector. Then, the light path enters the eyepiece group through the reflection of the fourth reflector, the fifth reflector, and the third optical input surface.
The laser light path received by the objective group enters the first prism and enters the second prism through the first reflector. The laser light path enters the laser receiver through the third reflector.

2. The telescope rangefinder according to in claim 1 is characterized in that the laser emission module comprises a laser emitter and a transmitting lens group on its transmitting optical path.

3. The telescope rangefinder according to in claim 1 is characterized in that the first prism and the second prism are fixed through a second light reflector and a second light input surface. A penetrating film layer conducive to laser input and output is plated between the second light reflector and the second light input surface.

4. The telescope rangefinder according to in claim 1 is characterized in that the laser transmitting module is interchangeable with the laser receiver.
